(19) United States
(12) Patent Application Publication
(10) Pub. No.: US 2006/0207268 A1
(43) Pub. Date: Sep. 21, 2006

(54) System and method for increasing the efficiency of a thermal management profile

(75) Inventors: Scott Edwards Kelso, Durham, NC (US); John Carl Mese, Cary, NC (US); Nathan J. Peterson, Raleigh, NC (US); Rod David Waltermann, Durham, NC (US); Arnold S. Weksler, Raleigh, NC (US)

Correspondence Address: SAWYER LAW GROUP LLP, PO BOX 51418, PALO ALTO, CA, 94303, US

(73) Assignee: International Business Machines Corporation, Armonk, NY (US)

(21) Appl. No.: 11/083,848

(22) Filed: Mar. 17, 2005

(51) Int. Cl. F23N 5/20; G05D 23/00; G01K 13/00

(52) U.S. Cl. 62/129; 236/1 C; 236/94

(57) ABSTRACT

A system and method for increasing the efficiency of a thermal management profile includes a central repository. The central repository is for receiving data for power consumption and location from equipment, combining the data with a current temperature near the equipment, and adjusting the current temperature based on the combined data.

### FIELD OF THE INVENTION

The present invention relates to energy management, and more particularly to a system and method for increasing the efficiency of a thermal management profile.

### BACKGROUND OF THE INVENTION

Equipment in buildings, particularly electronic equipment is increasingly becoming a major contributor of heat that affects building temperature. Traditional thermostats that control temperature solely by measuring ambient air temperature are inefficient, resulting in wasted energy to regulate the temperature in buildings. Additionally, thermostats are localized and do not factor in heat exchange across areas.

Accordingly, what is needed is a system and method for increasing the efficiency of a thermal energy management profile. The present invention addresses such a need.

### BRIEF SUMMARY OF THE INVENTION

The present invention provides a system and method for increasing the efficiency of a thermal management profile. The system includes a central repository for receiving data for power consumption and location from equipment, combining the data with a current temperature near the equipment, and adjusting the current temperature based on the combined data.

By factoring changing energy loads for electronic systems, a heating, ventilation and air conditioning (HVAC) system may predict changing thermal management needs throughout a building. Rather than wait for temperature to change at a thermostat, the invention takes into account changing energy loads to predict an increase or decrease in the amount of heat put out by equipment, providing information on impending changes to temperature at the sensor and adjusting the thermostat accordingly.

### BRIEF DESCRIPTION OF SEVERAL VIEWS OF THE DRAWINGS

FIG. 1 is a block diagram of one embodiment of the invention.

FIG. 2 is a flow diagram of one embodiment of the invention.

### DETAILED DESCRIPTION OF THE INVENTION

The present invention relates to a system and method for increasing the efficiency of a thermal management profile. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

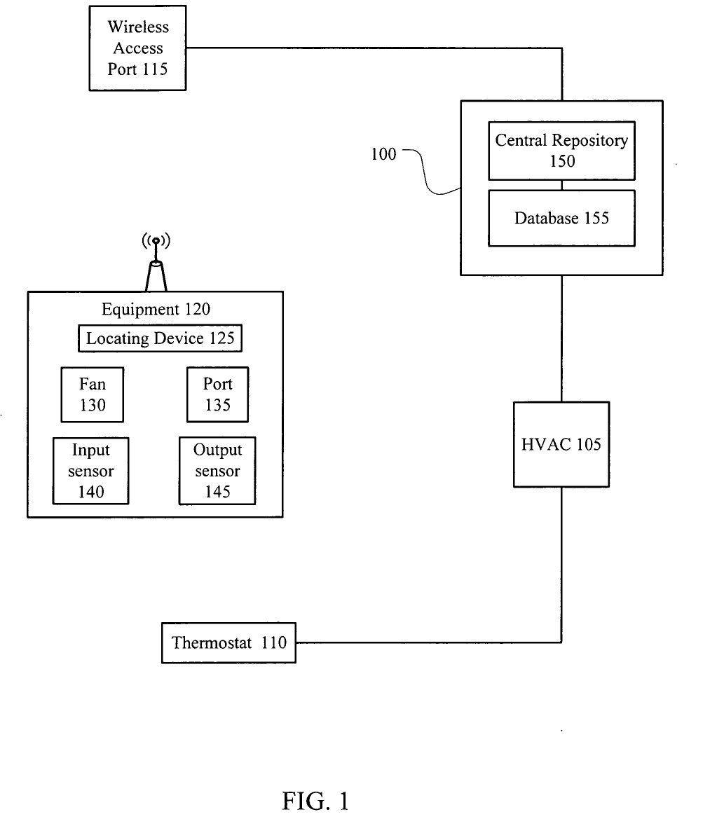

FIG. 1 is a block diagram of one embodiment of the invention in a system 100 that is connected to a heating, ventilation and air-conditioning (HVAC) unit 105. HVAC unit 105 is connected to a thermostat 110 in a building, for example. A wireless access port 115 may connect to the system 100. One or more pieces of electronic equipment 120, for example servers, computers, transformers, communication equipment, etc. are located in the building within some proximity to thermostat 110. Equipment 120 may be, for example, a personal computer and may include a locating device 125, for example a GPS, a fan 130 for moving air through the equipment's chassis, a port 135 for connecting to a network, wireless or wired, an input air temperature sensor 140 and an output air temperature sensor 145.

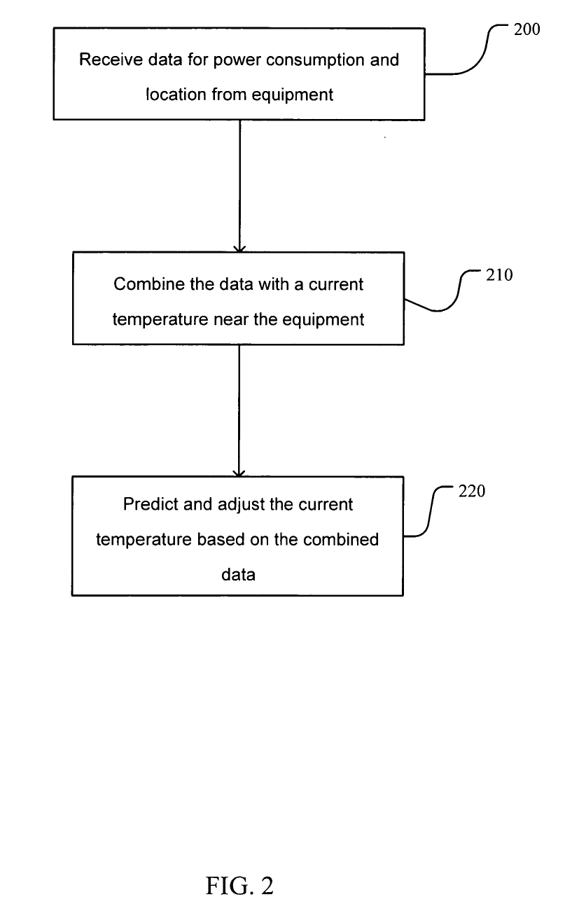

FIG. 2 is a flow diagram of one embodiment of the invention implemented with the system 100 of FIG. 1. FIG. 2 will be discussed in conjunction with FIG. 1 for illustrative purposes, though the method in FIG. 2 is not limited to the previously disclosed embodiment. In block 200, system 100 receives data for power consumption and location from equipment 120. The data may be received through wireless access port 115, which may alternatively have a wired connection to equipment 120 through port 135.

Power consumption data may be tracked through various methods, whether a battery monitor in a laptop, current and voltage meters in a server or transformer, and so on. Location may be inferred from a port address through a wired connection, or it may be tracked in another manner, such as through longitude and latitude coordinates from the locating device 125, for example from a GPS or RFID triangulation or wireless access point triangulation. In another embodiment, the identity of equipment 120 may be transmitted to central a repository 150, which may then receive the known location of equipment 120 from a database 155.

Data from equipment 120 may alternatively include temperature from the input air temperature sensor 140 or the output air temperature sensor 145 for the equipment. The data may also include fan speed from the fan 130.

Although the data from equipment 120 may be requested by system 100 at certain times or intervals, the data may also be periodically sent as part of an on-board software application (not show).

The system 100 has access to the HVAC system 105 and thermostat 110. Thermostat 110 provides the temperature at its sensor (not shown) to the HVAC system 105 and to system 100. In block 210, system 100 combines the data for power consumption with the current temperature, using the location derived from the location data to determine which thermostat is closest or most appropriate. The current temperature may be received from a thermostat nearby the equipment, for example. A thermostat further away from one piece of equipment may be more appropriate than a closer one if the one further away is in the same room, while the one closer is not.

In block 220, the system 100 predicts and adjusts the thermostat 110 based on the power consumption data. If power consumption jumps, system 100 may turn down thermostat 110 in order to preemptively activate air conditioning from the HVAC system 105, anticipating rising temperatures from equipment 120. If power consumption drops, air conditioning may be turned off with the expectation that the heat in the room will decrease with decreased load on equipment 120. By adjusting the expected heating and cooling needs based on energy consumption, the efficiency of the thermal management profile may be increased.

Alternatively, system 100 may measure the air sensor output temperature from equipment 120 and fan speed, and calculate how many British thermal units (BTU) are being added to a room, and adjust thermostat 110 accordingly.

In another embodiment, the system 100 may take temperature data from equipment 120 to supplement temperature data from the thermostat 110 and improve knowledge of the temperature gradients throughout a room or building.

According to the method and system disclosed herein, the present invention provides a system and method for increasing the efficiency of a thermal management profile. One skilled in the art will recognize that the particular standards used are exemplary, and any bandwidth-limited network may apply the invention in the above manner. The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

We claim:

1. A method for increasing the efficiency of a thermal management profile comprising:
receiving data for power consumption and location from equipment;
combining the data with a current temperature near the equipment; and
predicting the current temperature based on the combined data.

2. The method of claim 1, the data including temperature.

3. The method of claim 1, the data including input temperature for the equipment.

4. The method of claim 1, the data including output temperature for the equipment.

5. The method of claim 4, the data including speed of a fan for the equipment, combining the data further comprising:
calculating the aggregate number of thermal units being expelled from the equipment based on the speed and the output temperature.

6. The method of claim 1, further comprising:
requesting data for power consumption and location from equipment.

7. The method of claim 1, the current temperature from a thermostat.

8. A computer readable medium containing programming instructions for increasing the efficiency of a thermal management profile, the programming instructions comprising:
receiving data for power consumption and location from equipment;
combining the data with a current temperature near the equipment; and
predicting the current temperature based on the combined data.

9. The computer readable medium of claim 8, the data including temperature.

10. The computer readable medium of claim 8, the data including input temperature for the equipment.

11. The computer readable medium of claim 8, the data including output temperature for the equipment.

12. The computer readable medium of claim 11, the data including speed of a fan for the equipment, combining the data further comprising:
calculating the aggregate number of thermal units being expelled from the equipment based on the speed and the output temperature.

13. The computer readable medium of claim 8, the programming instructions further comprising:
requesting data for power consumption and location from equipment.

14. A system for increasing the efficiency of a thermal management profile comprising:
a central repository for receiving data for power consumption and location from equipment, combining the data with a current temperature near the equipment, and predicting the current temperature based on the combined data.

15. The system of claim 14, the data including temperature.

16. The system of claim 14, the data including input temperature for the equipment.

17. The system of claim 14, the data including output temperature for the equipment.

18. The system of claim 17, the data including speed of a fan for the equipment, the central repository further for calculating the aggregate number of thermal units being expelled from the equipment based on the speed and the output temperature.

19. The system of claim 14 the central repository further for requesting data for power consumption and location from equipment.

20. The system of claim 14 further comprising:
a database coupled to the central repository for storing the location of the equipment and transmitting the location to the central repository.
